(19) United States
(12) Patent Application Publication
(10) Pub. No.: US 2025/0249359 A1
(43) Pub. Date: Aug. 7, 2025

(54) Mobile Videogame

(71) Applicant: Severex PL SP z o.o., Warsaw (PL)

(72) Inventor: Alexey Nikolayevich GORYAYNOV, Minsk (BY)

(73) Assignee: Severex PL SP z o.o, .Warsaw (PL)

(21) Appl. No.: 18/597,056

(22) Filed: Mar. 6, 2024

Related U.S. Application Data
(60) Provisional application No. 63/548,660, filed on Feb. 1, 2024.

(51) Int. Cl. A63F 13/52; A63F 13/80

(52) U.S. Cl. CPC A63F 13/52; A63F 13/80

(57) ABSTRACT

The proposed method describes visual mechanics for answering questions generated by a videogame program executed by a videogame device. The method includes rendering on the display a question, answer choices determined and placed in an answer area by a user followed by the user's action, e.g. clicking. The question includes meaningful parts representing categories and their instances. The answer choices are enclosed into containers arranged on rings rendered on the display. The containers are placed into the answer area by the user, or some of them by the program. The device evaluates the answer and produces a Correct signal if the answer is correct, otherwise it produces an Incorrect signal. The answer choices are presented in text, image, sound, and other formats. The method provides users with functional gaming experience, provides developers with a competitive advantage in the videogame production and development market, and can be used for educational purposes.

### CROSS REFERENCES TO RELATED APPLICATIONS

The present patent application claims the benefit of a U.S. provisional patent application Ser. No. 63/548,660 filed on Feb. 1, 2024, the disclosure of which is incorporated herein in its entirety by reference.

### FIELD OF THE INVENTION

The proposed invention relates to videogames and applications, especially mobile and computer games (e.g. trivia games) and represents visual mechanics for answering questions generated by the videogame/application. The invention can provide users with functional gaming experience, and can also be used, for example, for educational purposes for children, adults, or perhaps even animals.

### BACKGROUND OF THE INVENTION

There are known multiple patents and publications dedicated to videogames. For example, “Video game system” is described in a Patent Publication US20010016517: “A video game system includes a video game machine, a memory medium and a controller. A CPU included in the video game machine detects a vibration generating condition that a player object comes into collision or contact with an enemy object or a stationary object. If the vibration generating condition is detected, the CPU drives a vibration source included in the controller, thereby generating vibration on the controller.” It is dedicated to a device being a combination of the video game machine and a vibration source capable of signaling to the user about a particular game event. Unlike the proposed invention, it is not related to visual mechanics for answering questions generated by the videogame/application.

Another example of related art is U.S. Pat. No. 9,174,128 that describes “Methods, systems, and computer programs are presented for executing a game and for creating computer-generated game quests, which are referred to as dynamic quests. One method includes an operation for identifying a template for creating a dynamic quest. The dynamic quest includes quest tasks and quest rewards, which are provided to a player upon completion of the quest tasks in the game. The template includes template tasks and template rewards. Further, the method includes an operation for selecting one or more template tasks for the quest tasks, and an operation for selecting one or more template rewards for the quest rewards. The dynamic quest is created in the game with the selected one or more template tasks and the selected one or more template rewards.” These methods and systems are complicated enough for implementation by developers. Also, they can hardly be used for education of young age children.

### BRIEF SUMMARY OF THE INVENTION

The proposed method of visual mechanics is a new way of providing for the user a number of options for answering questions that can be implemented in a videogame device, either online or offline that executes the inventive videogame.

The videogame device may include at least a digital processor capable of executing a videogame program, storage that stores the videogame program (e.g. in case of a personal computer, and the like), memory medium, input controllers (e.g. keyboard, mouse, gamepad, trackpad, joystick, motion tracker, microphone) and display (a monitor or smartphone screen, projector, etc.). Examples of the videogame device may include: a personal computer, notebook, game console, smartphone, arcade machine, VR/AR/MR helmet, and other known devices capable of launching, transmitting and interacting with the videogame.

The inventive method for executing visual mechanics is carried out by a videogame device including at least a display and a number of input controllers, wherein the videogame device is preprogrammed by a videogame program.

In preferred embodiments, the inventive method comprises the following steps: —rendering on the display a Question area that contains a question to be answered by a user; wherein the question includes at least a meaningful Part I and a meaningful Part II; —rendering on the display an Answer area; —rendering on the display a Reply bottom; —rendering on the display a number of rings including an outer ring and an inner ring, located inside the outer ring; —rendering on the display at least a plurality of outer containers situated respectively on the outer ring and a plurality of inner containers situated respectively on the inner ring; wherein the plurality of outer containers each contains one of a plurality of choices I related to the Part I, and the plurality of inner containers each contains one of a plurality of choices II related to the Part II; —placing, by the user or by the videogame program, an outer container containing a choice I chosen from the plurality of choices I into the Answer area; —placing, by the user, an inner container containing a choice II chosen from the plurality of choices II into the Answer area, resulting at least in an answer combination of the choice I and the choice II being placed in the Answer area; —subjecting the Reply bottom to an action by the user employing at least one of said number of input controllers; —evaluating by the videogame device a correctness of the answer combination with respect to the question; and —producing at least a Correct signal by the videogame device if the answer combination is determined to be correct by the videogame device; otherwise producing at least an Incorrect signal by the videogame device.

The plurality of inner containers each and the plurality of outer containers each may have a shape of a circle, or triangle, or square, or hexagon; or the plurality of inner containers each and the plurality of outer containers each are rendered on the display without explicit boundaries.

The Part I may represent a category of the question and the Part II may represent an instance of the category, or vice versa. The plurality of choices I and the plurality of choices II can be presented in the following formats: text, image, sound icon, video fragment, etc.

There are other embodiments of the invention that are disclosed herein and claimed in the claims herein below.

### BRIEF DESCRIPTION OF DRAWINGS OF THE INVENTION

FIG. 1 depicts a diagram showing a general outline of the display with its essential elements, according to a preferred embodiment of the instant invention.

FIG. 2 depicts diagrams showing two-ring options rendered on the display with their essential elements, according to preferred embodiments of the instant invention.

FIG. 3 depicts diagrams showing other two-ring options rendered on the display with their essential elements, according to preferred embodiments of the instant invention.

FIG. 4 depicts diagrams including two-ring options or forms of questions and answers rendered on the display with their essential elements, according to preferred embodiments of the instant invention.

FIG. 5 depicts diagrams showing three-ring options rendered on the display with their essential elements, according to preferred embodiments of the instant invention.

### DESCRIPTION OF PREFERRED EMBODIMENTS OF THE INVENTION

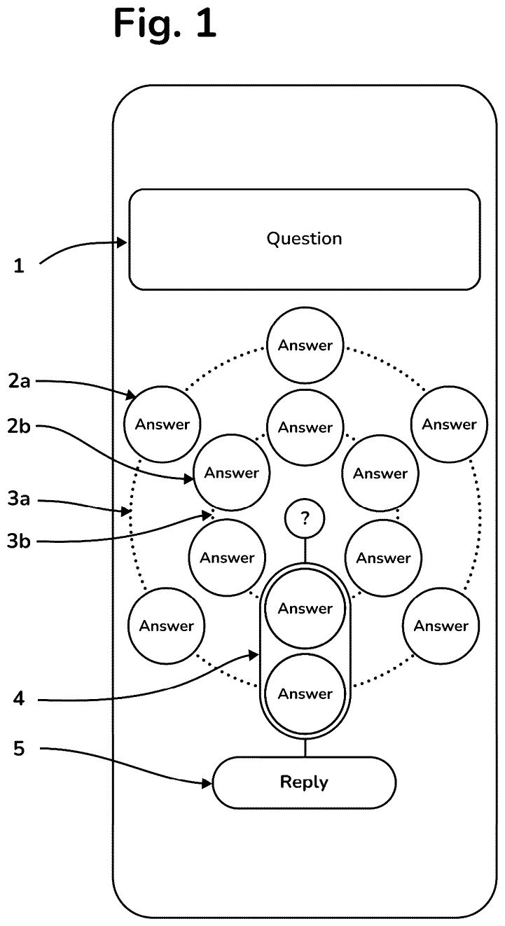

The proposed visual mechanics includes the following elements (FIG. 1):

In a preferred embodiment depicted on FIG. 1, the videogame device renders on the display a Question area 1 that contains a question presented in a text, visual (e.g. images, video fragments, etc.), audio, or another suitable format.

The question can be chosen from a plurality of questions preprogrammed and stored on the device, or alternatively generated by an external source, for example, an artificial intelligence system (AIS, such as neural network, etc.). The question can be chosen randomly or according to a specific algorithm determined by the consumer, or the developer, or the AIS. In most of embodiments of the invention, the question includes at least two meaningful portions that should be matched by the user in order to get a correct answer.

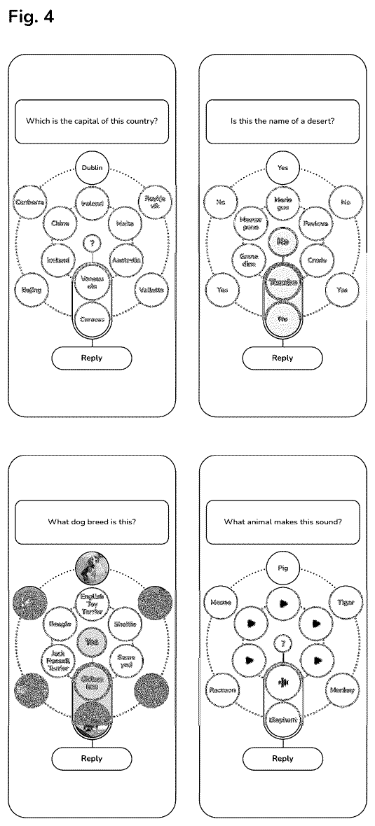

In a preferred embodiment depicted on FIG. 4, the first portion can be attributed to a category (e.g. plurality of dog breeds), while the second portion is attributed to an instance (a particular breed, such as Sheltie) of the category.

In a preferred embodiment depicted on FIG. 1, the videogame device renders on the display two concentric rings: an outer ring 3a and an inner ring 3b, located inside the outer ring 3a. The rings are capable of rotating around a common axis by the user utilizing known information input controllers, such as a touch screen (or, for example, a screen that senses movements of the user's fingers without touching the screen, etc.), computer mouse, joystick, keyboard, gamepad, trackpad, motion tracker, microphone and so on.

In other embodiments, three or more rotatable rings (each having a corresponding meaningful portion of the question) can be rendered on the display.

In a preferred embodiment depicted on FIG. 1, a number of answer choices for the question in the Question area 1 are enclosed in containers, presented preferably in the shape of circles (containers 2a, 2b). The containers 2a and 2b are rendered on the display being situated respectively on each of the rings (3a, 3b) and preferably evenly spaced.

In other embodiments, the answer choices can be enclosed in the containers having another suitable geometric shape, such as triangles, squares, hexagons, etc., or the answer choices can be rendered on the display without explicit boundaries (i.e. using ‘invisible’ containers).

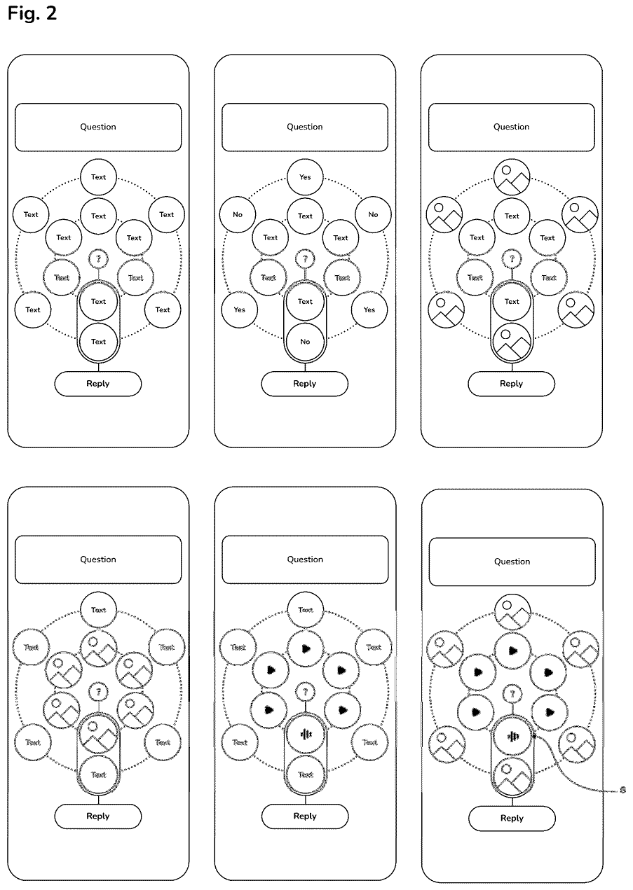

The answer choices can be presented on the display (depicted on FIG. 2) in the format of text, or an image (showing a photograph, picture, etc.), or a sound reproduction symbol wherein a number of audio signals-sounds are generated after the user's action. Such actions can be provided in the form of a click on the sound reproduction symbol, or touch, or movement of the user's fingers in front of the sound reproduction symbol on the display capable of sensing the movement, or utilizing another known method of interaction with videogame devices and employing the information input controllers mentioned above.

For example, FIG. 2 shows a sound reproduction symbol 6. The symbol 6 can invoke a single sound, a series of sounds, or, for example, a musical fragment, etc.

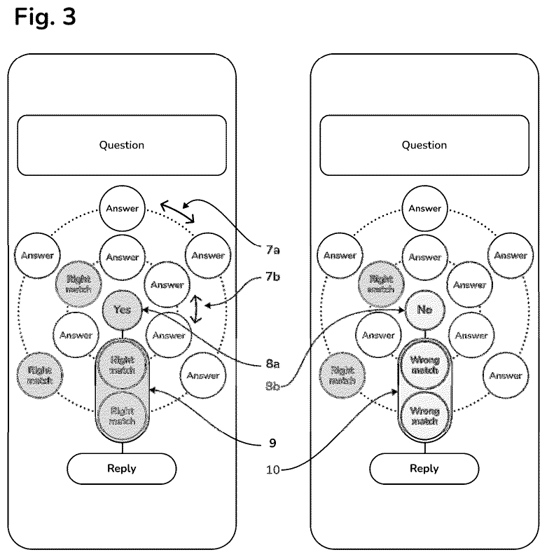

FIG. 1 shows an Answer area 4 for checking the correctness of the answer, where the answer option chosen on each of the rings 3a and 3b needs to be placed by the user in the Answer area 4 by rotating the rings 3a and 3b in directions 7a and 7b, as shown on FIG. 3, or, for example, by dragging the answer containers 2a and/or 2b into the Answer area 4.

In other embodiments, one of the containers (e.g. the container 2b containing the ‘country's name’) can be placed in the Answer area 4 by the videogame device program, while the second container (e.g. the container 2a containing the country ‘capital's name’) is to be placed by the user in the Answer area 4 by rotating the ring 3b, or, for example, by dragging the answer container 2a into the Answer area 4 in order to check the correctness of the answer.

FIG. 1 shows a Reply button 5 for checking the correctness of the answer, which needs to be pressed (or clicked, or activated by another known method, as mentioned above) by the user, after placing the answer containers 2a and 2b in the Answer area 4.

The proposed visual mechanics enables the user to match the correct numbers (e.g. pairs, when two rings 3a and 3b are used, as shown on FIG. 1) of answer choices in the containers (2a and 2b) and press or click (or apply another known method of interaction with videogame devices as mentioned above) on the Reply button 5. When checking an answer, the videogame device analyzes the matching of choices of the answers in the containers in the Answer area 4.

In the two-ring embodiment (rings 3a and 3b as shown on FIG. 1), the answer choice in the container 2a must be correctly matched with the answer choice in the container 2b in the Answer area 4.

As shown on FIG. 3, if one of the answer choices is not correct, an Incorrect signal is produced by the videogame device, e.g. the answer is not scored (which essentially represents a visual signal shown by a shaded area 10 on FIG. 3) that can be additionally indicated by the appearance of a visual “negative” symbol “No” 8b and/or an audible “negative” signal (e.g. an irritating sound). In some embodiments, an incorrect answer can be negatively scored (e.g. −1).

However, if both of the answer choices in the containers 2a and 2 b are correctly matched, a Correct signal is produced by the videogame device, e.g. the answer will be scored as correct (shown by a shaded area 9 on FIG. 3) that can be additionally indicated by the appearance of a visual “positive” symbol 8a and/or an audible “positive” signal (e.g. a pleasant ring sound). In some embodiments, a correct answer can be positively scored (e.g. +1).

Several examples of questions and answers related to the questions are illustrated in the diagrams of FIG. 4. As three of them show, each question contains meaningful parts: Part I and Part II. These two parts are represented by a category and its instance, e.g.: “country” (category) and “capital of the country” (its instance); “dog” (category) and “breed of the dog” (its instance); “animal” (category) and “sound the animal makes” (its instance) that should be matched by the user.

Also, on FIG. 4 there is shown another example: the containers 2a contain a number of Yes answers and a number of No answers, while the containers 2b each presents a text fragment (optionally, it can be presented in another format, e.g. image). The question (in the Question area 1) contains a meaningful Part I (category I, represented by “desert”) and a meaningful Part II (category II, represented by “name”). The user is required determining if any instance of category II in the containers 2b is also correlated to category I (i.e. essentially matching an instance of category I).

If the user believes that such an instance of category II presented in one of the containers 2b (a chosen container), the chosen container 2b and a Yes container 2a are placed into the Answer area 4, and the Reply bottom 5 is subjected to the user's action (pressing, clicking, etc.). If the user believes that there is no instance of category II is presented in any of the containers 2b, anyone of the containers 2b and a No container 2a are placed by the user into the Answer area 4, and then the Reply bottom 5 is subjected to the user's action (pressing, clicking, etc.). If the videogame device registers a match, a Correct signal will be issued; otherwise an Incorrect signal will be issued by the videogame device.

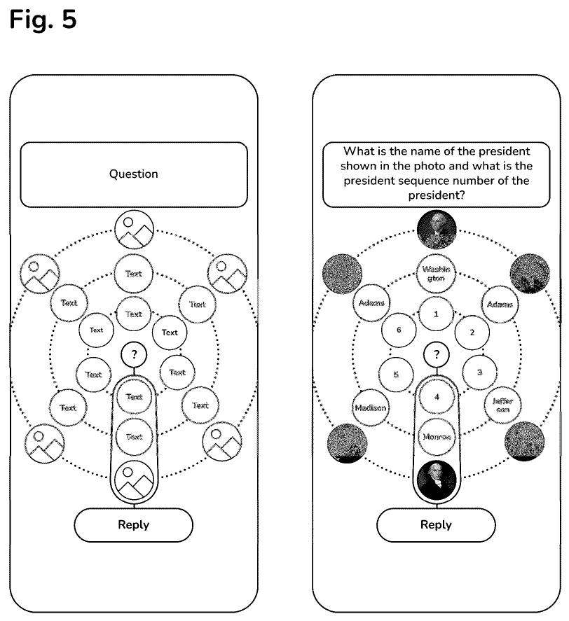

In other embodiments, a question (in the Question area 1) may consist of three or more parts that may include three or more categories, as shown on FIG. 5. Such embodiments of the videogame may incorporate and render on the display three or more rings similar to the rings 3a and 3b and corresponding containers similar to the containers 2a and 2b.

In other embodiments depicted on FIG. 5, an inner ring, a middle ring, and an outer ring are rendered on the display. A number of inner ring containers (inner containers), a number of middle ring containers (middle containers), and number of outer ring containers (outer containers), situated on the corresponding rings, are rendered on the display. The question in the Question area 1 rendered on the display. The question includes three meaningful parts: Part I, Part II, and Part III. Part I (“What is the name of the president”) is attributed to a category I (a plurality of names of U.S. presidents), represented by a plurality of instances I of the category I (particular names of the presidents in the text format) contained in the middle containers; Part II (“what is the president sequence number of the president?”) is attributed to a category II (a plurality of sequence numbers of U.S. presidents) represented by a plurality of instances II (sequence numbers of the presidents presented in the text format) of the category II contained in the inner containers; and Part III is attributed to a category III, represented by a plurality of instances III (a number of photographs of the presidents presented in the image format) of the category III contained in the outer containers.

There are the following options available in the forgoing embodiments of the inventive method: (a) a particular instance III can be placed in the Answer area by the videogame program, while an instance II and an instance I are placed by the user; (b) in another embodiment, a particular instance II can be placed in the Answer area by the videogame program, while an instance I and an instance III are placed by the user; (c) in another embodiment, a particular instance I can be placed in the Answer area by the videogame program, while an instance II and an instance III are placed by the user; and (d) in another embodiment, an instance I, an instance II and an instance III all can be placed in the Answer area by the user.

As an example, for option (a): if the user believes that an instance I chosen from the plurality of instances I, and an instance II chosen from the plurality of instances II, match the particular instance III chosen from the plurality of instances III, the corresponding middle container and corresponding inner container are placed by the user into the Answer area 4 by the user, and the Reply bottom 5 is subjected to the user's action (pressing, clicking, etc.). If the videogame device registers a match of the instances I, II, and III, a Correct signal will be issued; otherwise an Incorrect signal will be issued by the videogame device. Similar steps may be used for option (b) and option (c), using the corresponding instances I, II, and III.

The inventive visual mechanics method proposes a new interactive form of question answering in videogames and applications, providing an engaging and functional gaming experience for the user.

Also, the inventive visual mechanics provides the users with an educational experience, as well as provides videogame developers with a competitive advantage in the videogame production and app development market.

I claim:

1. A method for executing visual mechanics carried out by a videogame device including at least a display and a number of input controllers, wherein said videogame device is preprogrammed by a videogame program; said method comprising the steps of:
rendering on the display a Question area that contains a question to be answered by a user; wherein the question includes at least a meaningful Part I and a meaningful Part II;
rendering on the display an Answer area;
rendering on the display a Reply bottom;
rendering on the display a number of rings including an outer ring and an inner ring, located inside the outer ring;
rendering on the display at least a plurality of outer containers situated respectively on the outer ring and a plurality of inner containers situated respectively on the inner ring; wherein the plurality of outer containers each contains one of a plurality of choices I related to the Part I, and the plurality of inner containers each contains one of a plurality of choices II related to the Part II;
placing, by the user or by the videogame program, an outer container containing a choice I chosen from the plurality of choices I into the Answer area;
placing, by the user, an inner container containing a choice II chosen from the plurality of choices II into the Answer area, resulting at least in an answer combination of the choice I and the choice II being placed in the Answer area;
subjecting the Reply bottom to an action by the user employing at least one of said number of input controllers;
evaluating by the videogame device a correctness of the answer combination with respect to the question; and
producing at least a Correct signal by the videogame device if the answer combination is determined to be correct by the videogame device; otherwise producing at least an Incorrect signal by the videogame device.

2. The method according to claim 1, wherein the plurality of inner containers each and the plurality of outer containers each have a shape of circles, or triangles, or squares, or hexagons; or the plurality of inner containers each and the plurality of outer containers each are rendered on the display without explicit boundaries.

3. The method according to claim 1, wherein: said Part I represents a category of the question and said Part II represents an instance of the category.

4. The method according to claim 3, wherein: the plurality of choices I and the plurality of choices II are presented in the following formats: text, image, sound icon, and video fragments.

5. The method according to claim 1, wherein: said Part II represents a category of the question, and said Part I represents an instance of the category.

6. The method according to claim 5, wherein: the plurality of choices I and the plurality of choices II are presented in the following formats: text, or image, or sound icon, or video fragments.

7. A method for executing visual mechanics carried out by a videogame device including at least a display and a number of input controllers, wherein said videogame device is preprogrammed by a videogame program; said method comprising the steps of:
rendering on the display a Question area that contains a question to be answered by a user; wherein the question includes at least a meaningful Part I represented by a category I and a meaningful Part II represented by a category II;
rendering on the display an Answer area;
rendering on the display a Reply bottom;
rendering on the display a number of rings including an outer ring and an inner ring, located inside the outer ring;
rendering on the display at least a plurality of outer containers situated respectively on the outer ring and a plurality of inner containers situated respectively on the inner ring; wherein the plurality of outer containers contain a number of Yes containers and a number of No containers, and the plurality of inner containers each contains one of a plurality of choices II related to the category II;
placing, by the user or by the videogame program, an inner container containing a choice II chosen from the plurality of choices II into the Answer area;
placing, by the user, a Yes container, chosen from the number of Yes containers, or a No container, chosen from the number of No containers, into the Answer area, resulting in an answer combination of the choice II and said Yes container being placed in the Answer area, or an answer combination of the choice II and said No container being placed in the Answer area;
subjecting the Reply bottom to an action by the user employing at least one of said number of input controllers;
evaluating by the videogame device a correctness of the answer combination with respect to the question; and
producing at least a Correct signal by the videogame device if the answer combination is determined to be correct by the videogame device; otherwise producing at least an Incorrect signal by the videogame device.

8. A method for executing visual mechanics carried out by a videogame device including at least a display and a number of input controllers, wherein said videogame device is preprogrammed by a videogame program; said method comprising the steps of:
rendering on the display a Question area that contains a question to be answered by a user; wherein the question includes at least a meaningful Part I represented by a category I, a meaningful Part II represented by a category II, and a meaningful Part III represented by a category III;
rendering on the display an Answer area;
rendering on the display a Reply bottom;
rendering on the display an outer ring, a middle ring located inside the outer ring, and an inner ring located inside the middle ring;
rendering on the display a plurality of outer containers situated respectively on the outer ring, wherein the outer containers each contains one of a plurality of instances I of the category I; a plurality of middle containers situated respectively on the middle ring, wherein the middle containers each contains one of a plurality of instances II of the category II; and a plurality of inner containers situated respectively on the inner ring, wherein the inner containers each contains one of a plurality of instances III of the category III;
placing
(a) by the videogame program an inner container chosen from the plurality of inner containers into the Answer area, and placing by the user an outer container chosen from the plurality of outer containers and a middle container chosen from the plurality of middle containers into the Answer area, resulting in a first answer combination; or
(b) by the videogame program a middle container chosen from the plurality of middle containers into the Answer area, and placing by the user an outer container chosen from the plurality of outer containers and a middle container chosen from the plurality of middle containers into the Answer area, resulting in a second answer combination; or
(c) by the videogame program an outer container chosen from the plurality of outer containers into the Answer area, and placing by the user a middle container chosen from the plurality of middle containers and an inner container chosen from the plurality of inner containers into the Answer area, resulting in a third answer combination;
subjecting the Reply bottom to an action by the user employing at least one of said number of input controllers;
evaluating by the videogame device a correctness of the first answer combination, or the second answer combination, or the third answer combination, with respect to the question; and
producing a Correct signal by the videogame device if the first answer combination, or the second answer combination, or the third answer combination is determined to be correct by the videogame device; otherwise producing an Incorrect signal by the videogame device.
